(19) United States
(12) Patent Application Publication
(10) Pub. No.: US 2005/0285847 A1
(43) Pub. Date: Dec. 29, 2005

(54) Display apparatus, display system and control method thereof

(76) Inventor: Soon-hoon Hwang, Yongin-si (KR)

Correspondence Address: STANZIONE & KIM, LLP, 919 18TH STREET, N.W., SUITE 440, WASHINGTON, DC, 20006, US

(21) Appl. No.: 11/143,442

(22) Filed: Jun. 3, 2005

(30) Foreign Application Priority Data
Jun. 28, 2004 (KR) 2004-49145

(51) Int. Cl. G09G 5/00

(52) U.S. Cl. 345/204

(57) ABSTRACT

A display system including a display apparatus having an interface part to receive a video signal, a display part to display a picture thereon, a signal processing part to convert a format of the video signal to be displayable in the display part, and a controller to control the display part and/or the signal processing part to adjust a display state of the picture displayed on the display part, and a computer having a main memory, a graphic controller to output the video signal to the display apparatus and capable of bi-directional communication with the interface part, and a RAM-resident control routine resident in the main memory to allow the graphic controller to output a predetermined control signal corresponding to an event signal to the display apparatus when the event signal is sensed, wherein the controller controls the display part and/or the signal processing part on the basis of the control signal received through the interface part. With this configuration, the present general inventive concept provides a display apparatus, a display system and a control method thereof, in which a random access memory (RAM)-resident control routine resident in a main memory of a computer senses a predetermined event signal and outputs a control signal corresponding to the sensed event signal to the display apparatus, so that the display apparatus executes a preset operation corresponding to the control signal.

### CROSS-REFERENCE TO RELATED APPLICATIONS

This application claims the benefit of Korean Patent Application No. 2004-49145, filed on Jun. 28, 2004, in the Korean Intellectual Property Office, the disclosure of which is incorporated herein in its entirety and by reference.

### BACKGROUND OF THE INVENTION

1. Field of the Invention

The present general inventive concept relates to a display apparatus, a display system and a control method thereof, and more particularly, to a display apparatus, a display system and a control method thereof, in which a random access memory (RAM)-resident control routine residing in a main memory of a computer senses a predetermined event signal and outputs a control signal corresponding to the sensed event signal to the display apparatus, so that the display apparatus executes a preset operation corresponding to the control signal.

2. Description of the Related Art

As a conventional display apparatus, a cathode ray tube (CRT) has been generally used, but the CRT is relatively heavy and thick and consumes a relatively large amount of electric power. Therefore, a current trend is replacing the CRT with a flat display panel (FDP). Here, the flat display panel is used to display a picture thereon and includes a liquid crystal display (LCD), a plasma display panel (PDP), etc.

The display apparatus, particularly a monitor for a computer, is passively operated relative to the computer. For example, the display apparatus just passively displays a picture based on a video signal received from the computer and processed though a preset processing routine.

Further, in the case of power management of the display apparatus, particularly, in the case of DPMS (display power management signaling) of VESA (video electronics standard association), the power of the display apparatus is managed on the basis of a DPMS signal output from a graphic controller of the computer. In this case, the display apparatus is passively operated relative to the computer.

Meanwhile, the display apparatus is operated independently of a state of the computer or a state of the video signal transmitted from the computer. For example, in the case of an auto adjustment provided in the flat display panel, when a user pushes an auto adjustment button provided in the display apparatus, horizontal and vertical positions, horizontal and vertical sizes, phase, etc., of the display apparatus are automatically adjusted on the basis of the video signal input to the display apparatus.

However, in a conventional display system comprising a computer and a display apparatus, the computer and the display apparatus are operated independently of each other, and thus the respective states of the display apparatus and the computer are not reflected to each other.

For example, when a user selects the auto adjustment of the display apparatus, the video signal output from the computer may not be adapted to execute the auto adjustment. That is, in a case where an edge region of a screen is dark, for example, a screen for a game or the like, the auto adjustment can fail.

Further, in the case where a user wants to listen to music through a speaker provided in the display apparatus, the computer may output the DPMS signal to the display apparatus after a lapse of a predetermined period of time. In this case, the display apparatus is turned off, and thus the speaker is also likely to be turned off.

Therefore, there is a need for a computer and a display apparatus of a display system to mutually recognize the respective states thereof and interlock with each other.

### SUMMARY OF THE INVENTION

Accordingly the present general inventive concept provides a display apparatus, a display system and a control method thereof, in which a random access memory (RAM)-resident control routine residing in a main memory of a computer senses a predetermined event signal and outputs a control signal corresponding to the sensed event signal to the display apparatus, so that the display apparatus executes a preset operation corresponding to the control signal.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a display system comprising a display apparatus comprising an interface part to receive the video signal, a display part to display a picture thereon, a signal processing part to convert a format of the video signal to be displayable in the display part, and a controller to control the display part and/or the signal processing part to adjust a display state of the picture displayed on the display part, and a computer comprising a main memory, a graphic controller to output the video signal to the display apparatus and capable of bi-directional communication with the interface part, and a RAM-resident control routine residing in the main memory to allow the graphic controller to output a predetermined control signal corresponding to an event signal to the display apparatus when the event signal is sensed, the controller controlling the display part and/or the signal processing part on the basis of the control signal received through the interface part.

The display apparatus may comprise an auto adjustment selecting part to select an auto adjustment, wherein the controller outputs a first event signal corresponding to the selection of the auto adjustment to the computer through the interface part when the auto adjustment is selected, the RAM-resident control routine outputs a predetermined video signal to provide the auto adjustment and a first control signal to execute the auto adjustment to the display apparatus when the first event signal corresponding to the selection of the auto adjustment is received through the graphic controller, and the controller analyzes characteristics of the video signal to provide the auto adjustment received through the interface part and executes the auto adjustment when the first control signal to execute the auto adjustment is sensed.

The controller may output a second event signal corresponding to an end of the auto adjustment to the computer through the interface part when the auto adjustment is ended, and the RAM-resident control routine then stops outputting the video signal to provide the auto adjustment through the graphic controller by sending a second control signal to end the auto adjustment to the graphic controller when the second event signal corresponding to the end of the auto adjustment is received through the graphic controller.

The computer may further comprise a user input unit to output a key signal corresponding to a user's selection, and a key signal sensor to sense whether the key signal is output from the user input unit, and the display part of the display apparatus may comprise an LCD panel, and a backlight unit to illuminate the LCD panel, wherein the key signal sensor outputs a third event signal corresponding to no key signal when there is no key signal from the user input unit within a predetermined period of time, the RAM-resident control routine outputs a third control signal to turn off the backlight unit through the graphic controller when the event signal corresponding to the no key signal is received from the key signal sensor, and the controller controls the backlight unit to be turned off when the third control signal to turn off the backlight unit is received through the interface part.

The key signal sensor may output a fourth event signal corresponding to an output of the key signal when the key signal is output from the user input unit from a state in which there is no key signal, wherein the RAM-resident control routine outputs a fourth control signal to turn on the backlight unit through the graphic controller when the fourth event signal corresponding to the output of the key signal is received from the key signal sensor, and the controller controls the backlight unit to be turned on when the fourth control signal to turn on the backlight unit is received through the interface part.

The key signal sensor may include an operating system.

The controller may display an OSD (on screen display) on the display part to select one of a function-on and a function-off, wherein the controller controls the display part and/or the signal processing part on the basis of the control signal in a case where the function-on is selected through the OSD, and the controller does not react to the control signal in a case where the function-off is selected through the OSD.

The foregoing and/or other aspects and advantages of the present general inventive concept may also be achieved by providing a method of controlling a display system having a display apparatus and a computer to output a video signal to the display apparatus, the method comprising providing a RAM-resident control routine in a main memory of the computer when the computer is turned on, allowing the RAM-resident control routine to sense whether a predetermined event signal is generated, outputting a control signal from the RAM resident control routine to the display apparatus corresponding to the event signal when the event signal is sensed through the RAM-resident control routine, and controlling the display apparatus on the basis of the control signal.

The method may further comprise selecting an auto adjustment, outputting a first event signal corresponding to the selection of the auto adjustment from the display apparatus to the computer, outputting a predetermined video signal to provide the auto adjustment and a first control signal to execute the auto adjustment from the RAM-resident control routine to the display apparatus when the first event signal corresponding to the selection of the auto adjustment is received through the graphic controller, analyzing characteristics of the video signal to provide the auto adjustment received through the interface part, and executing the auto adjustment when the first control signal to execute the auto adjustment is sensed.

The method may further comprise outputting a second event signal corresponding to an end of the auto adjustment from the display apparatus to the computer when the auto adjustment is ended, and stopping the outputting of the video signal to provide the auto adjustment by outputting a second control signal to end the auto adjustment to the graphic controller when the second event signal corresponding to the end of the auto adjustment is transmitted to the computer.

The computer may further comprise a user input unit to output a key signal corresponding to a user's selection, and the display apparatus may comprise a display part having an LCD panel to display a picture thereon, and a backlight unit to illuminate the LCD panel, and the method may further comprise sensing whether a key signal is output from the user input unit, outputting a third event signal corresponding to no key signal when there is no key signal output from the user input unit within a predetermined period of time, outputting a third control signal to turn off the backlight unit from the RAM-resident control routine to the display apparatus when the third event signal corresponding to the no key signal is received to the RAM-resident control routine, and turning off the backlight unit on the basis of the third control signal to turn off the back light unit received from the computer.

The method may further comprise outputting a fourth event signal corresponding to an output of the key signal when the key signal is output from the user input unit from a state in which there is no key signal, outputting a fourth control signal to turn on the backlight unit from the RAM-resident control routine to the display apparatus when the fourth event signal corresponding to the output of the key signal is received through the RAM-resident control routine, and turning on the backlight unit on the basis of the fourth control signal to turn on the back light unit received from the computer.

The foregoing and/or other aspects and advantages of the present general inventive concept may also be achieved by providing a display apparatus comprising an interface part to receive a video signal from a computer; a display part to display a picture thereon, a signal processing part to convert a format of the video signal to be displayable in the display part, an auto adjustment selecting part to select an auto adjustment, and a controller to output an event signal to the computer corresponding to the selection of the auto adjustment through the interface part when the auto adjustment is selected through the auto adjustment selecting part, to control the signal processing part and/or the display part to display the picture on the display part on the basis of a video signal to provide the auto adjustment received from the computer through the interface part corresponding to the event signal, and to control the signal processing part and the display part to execute the auto adjustment on the basis of a control signal received from the computer through the interface part corresponding to the event signal.

### BRIEF DESCRIPTION OF THE DRAWINGS

The above and/or other aspects and advantages of the present general inventive concept will become apparent and more readily appreciated from the following description of the embodiments, taken in conjunction with the accompany drawings of which:

FIG. 1 is a control block diagram of a display system according to an embodiment of the present general inventive concept;

FIG. 2 is a control block diagram of a display system according to another embodiment of the present general inventive concept;

FIG. 3 is a control flowchart of the display system of FIG. 2;

FIG. 4 is a control block diagram of a display system according to another embodiment of the present general inventive concept; and

FIG. 5 is a control flowchart of the display system of FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

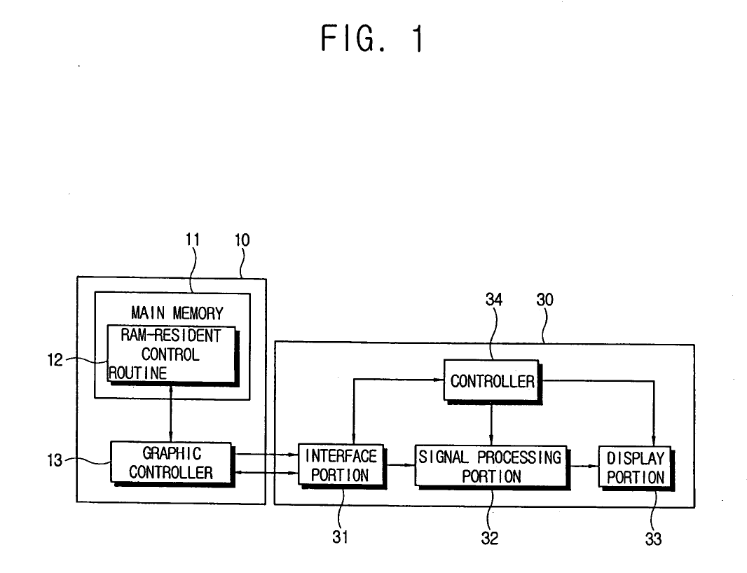

As shown in FIG. 1, a display system according to an embodiment of the present general inventive concept comprises a display apparatus 30 to display a picture, and a computer 10 to output a video signal to the display apparatus 30.

The display apparatus 30 may comprise an interface portion 31 to receive the video signal, a display portion 33 to display the picture thereon, a signal processing portion 32 to convert a format of the video signal to be displayable on the display portion 33; and a controller 34 to control the interface portion 31, the display portion 33, and the signal processing portion 32.

The interface portion 31 receives the video signal output from a graphic controller 13 of the computer 10. Here, the video signal output from the graphic controller 13 may include RGB (red, green, blue) signals, and horizontal and vertical synchronous (HN sync) signals. Further, the interface portion 31 may include various configurations such as a D-Sub terminal, a DVI terminal, etc., as long as it is connectable to the graphic controller 13 of the computer 10.

Further, the interface portion 31 provides a bi-directional interface with the computer 10. Thus, the computer 10 can transmit data in addition to the video signal to the display apparatus 30. Further, the display apparatus 30 can transmit its own information to the computer 10.

The interface portion 31 can support a display data channel (DDC) interface capable of bi-directional communication with the computer 10, such as, for example, a DDC-DI interface. Here, the DDC interface may be developed by VESA (video electronics standard association) in order to support a configuration auto setting, so called, plug-and-play, and may define signal lines and a priority of the signal lines when the computer 10 and the display apparatus 30 communicate data with each other. Further, the controller 34 of the display apparatus 30 can transmit an event signal (to be described later) to the computer 10 through the DDC interface, and the computer 10 can transmit a control signal (to be described later) to the display apparatus 30 through the DDC interface.

The display portion 33 can be configured with various display modules. For example, the display portion 33 may include a digital light processing (DLP), a liquid crystal display (LCD), a plasma display panel (PDP), or the like.

The signal processing portion 32 can have various configurations according to formats of the video signal input through the interface portion 31. For example, the signal processing portion 32 may comprise a scaler (not shown) to scale the video signal to have vertical frequency, resolution, aspect ratio, and the like adapted to a rated output of the display part 33, and a signal converter (not shown) having at least one of a TMDS (transition minimized differential signaling) receiver, an A/D converter, a video decoder, and a tuner to convert the video signal input through the interface portion 31 into digital RGB signals to be processed by the scaler corresponding to the formats of the video signal.

The controller 34 controls the signal processing portion 32 and the display portion 33. Here, the controller 34 can control the signal processing portion 32 and the display portion 33 to adjust a display state, e.g., brightness, resolution, contrast, position, size, etc., of a picture displayed on the display portion 33 on a basis of preset parameters.

Further, the controller 34 can control the display portion 33 and/or the signal processing portion 32 on the basis of the control signal received from the computer 10 through the interface portion 31, which will be described later.

Meanwhile, the computer 10 comprises a main memory 11, such as a RAM (random access memory), the graphic controller 13 to output the video signal, and a RAM-resident control routine 12 residing in the main memory 11. The RAM-resident control routine 12 can reside in the RAM as a RAM-resident program to continuously run while the computer 10 is operating.

The RAM-resident control routine 12 can detect whether the event signal is generated, and when the event signal is generated and detected, the RAM-resident control routine 12 allows the graphic controller 13 to output the control signal corresponding to the event signal to the display apparatus 30. At this time, the controller 34 of the display apparatus 30 can control the display portion 33 and/or the signal processing portion 32 on the basis of the control signal received through the interface portion 31.

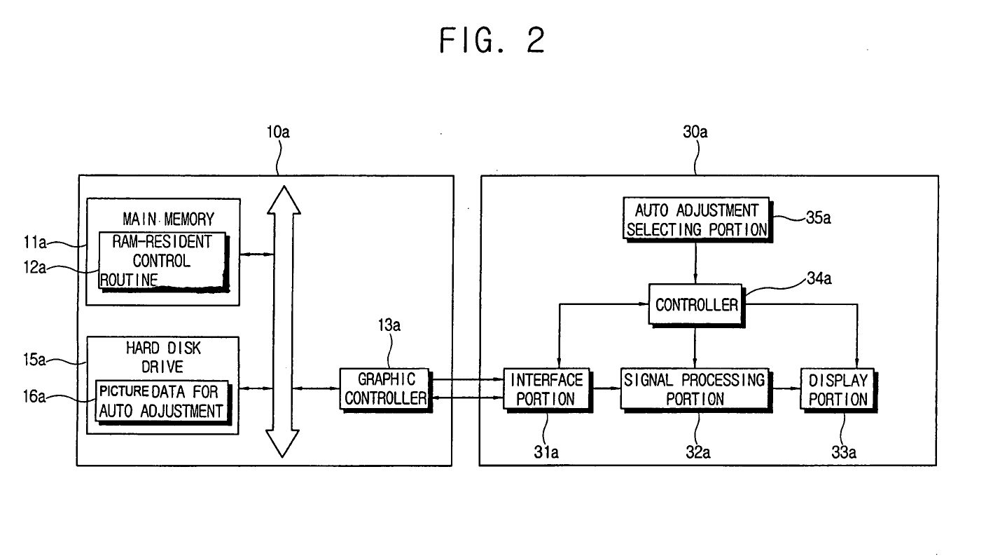

Hereinbelow, a display system according to another embodiment of the present general inventive concept will be described with reference to FIG. 2. The display system of FIG. 2 may comprise a display apparatus 30a to display a picture, and a computer 10a to output a video signal to the display apparatus 30a.

The display apparatus 30a may comprise an auto adjustment selecting portion 35a to select an auto adjustment, in addition to an interface portion 31a, a signal processing portion 32a, a display portion 33a, and a controller 34a. The interface portion 31a, the signal processing portion, 32a, the display portion 33a, and the controller 34a are similar to the interface portion 31, the signal processing portion 32, the display portion 33, and the controller 34 described above (see FIG. 1). The auto adjustment of the display apparatus 30a allows the controller 34a to adjust preset parameters about display states of the picture displayed on the display portion 33a. For example, the parameters such as horizontal and vertical positions, horizontal and vertical sizes, phase, etc., of a picture displayed on the display portion 33a can be automatically adjusted in the display apparatus 30a according to characteristics of the video signal input through the interface portion 31a.

Here, the auto adjustment selecting portion 35a can be provided as a button placed on the outside of the display apparatus 30a, a remote controller, etc.

When a user selects the auto adjustment through the auto adjustment selecting portion 35a, the controller 34a of the display apparatus 30a outputs an event signal (hereinafter, referred to as “first event signal”) corresponding to the selection of the auto adjustment to the computer 10a through the interface portion 31a. Further, the controller 34a delays executing the auto adjustment until it receives a control signal to execute the auto adjustment (hereinafter, referred to as “first control signal”) output from the computer 10a corresponding to the first event signal.

The computer 10a receives the first event signal from the display apparatus 30a through a graphic controller 13a.

When the first event signal is received through the graphic controller 13a, a RAM-resident control routine 12a outputs a predetermined video signal to provide the auto adjustment and the first control signal to execute the auto adjustment to the display apparatus 30a when the first event signal corresponding to the selection of the auto adjustment is received through the graphic controller 13a.

Further, when the predetermined video signal to provide the auto adjustment and the first control signal are received through the interface portion 31a, the controller 34a of the display apparatus 30a analyzes the received video signal to provide the auto adjustment and executes the auto adjustment, thereby adjusting the display state of the picture displayed on the display part 33a.

The video signal to provide the auto adjustment may include information about a picture suitable to allow the controller 34a of the display apparatus 30a to analyze the characteristics of the video signal so as to execute the auto adjustment. For example, the picture based on the video signal for the auto adjustment may have a high brightness in an edge region thereof, and a color signal.

Picture data 16a corresponding to the video signal to be used for the auto adjustment can be, as shown in FIG. 2, stored in a hard disk drive 15a. Further, the picture data 16a to be used for the auto adjustment, together with the RAM-resident control routine 12a, may be resident in a main memory 11a while the computer 10a is operating.

When the auto adjustment is ended, the controller 34a of the display apparatus 30a outputs an event signal (hereinafter, referred to as “second event signal”) to the computer 10a through the interface portion 31a corresponding to the end of the auto adjustment.

Further, when the second event signal is detected through the graphic controller 13a, the RAM-resident control routine 12a of the computer 10a stops the graphic controller 13a from outputting the video signal to provide the auto adjustment by sending a second control signal to stop the auto adjustment to the graphic controller 13a.

Thus, even though a user may select the auto adjustment to be executed while a program containing a picture inadequate for the execution of the auto adjustment is running, that is, while a program such as a game containing a picture having a dark region at an edge thereof is running, the computer 10a transmits the video signal adapted to provide the selection of the auto adjustment to the display apparatus 30a. Therefore, the auto adjustment is executed regardless of the display state of a current picture displayed on the display portion 33a, thereby minimizing a probability of failure in the execution of the auto adjustment.

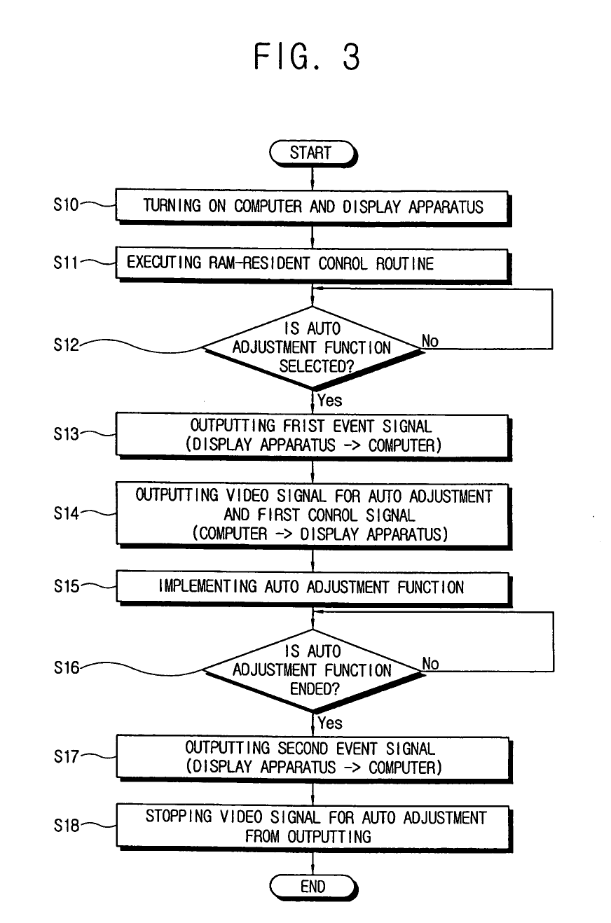

Hereinbelow, a control method of the display system of FIG. 2 will be described with reference to FIG. 3.

At operation S10, the computer 10a and the display apparatus 30a are turned on, wherein that the computer 10a starts booting. At operation S11, the RAM-resident control routine 12a is executed after booting the computer 10a and resides in the main memory 11a.

At operation S12, the controller 34a of the display apparatus 30a senses whether a user selects the auto adjustment through the auto adjustment selecting portion 35a. When the auto adjustment is selected, at operation S13, the controller 34a of the display apparatus 30a outputs the first event signal to the computer 10a through the interface portion 31a.

At operation S14, when the first event signal is received from the display apparatus 30a, the RAM-resident control routine 12a allows a DDC interface of the graphic controller 13a to output the video signal to provide the auto adjustment and the first control signal to the display apparatus 30a.

At operation S15, when the first control signal is sensed through the interface part 31a, the controller 34a of the display apparatus 30a analyzes the characteristics of the video signal to provide the auto adjustment received through the interface portion 31a, and thereby executes the auto adjustment.

At operation S16, the display apparatus 30a senses whether the auto adjustment function is ended, and when the auto adjustment is ended, at operation S17, the controller 34a of the display apparatus 30a outputs the second event signal to the computer 10a through the interface portion 31a corresponding to the end of the auto adjustment.

At operation S18, when the second event signal is detected through the graphic controller 13a, the RAM-resident control routine 12a of the computer 10a stops the graphic controller 13a from outputting the video signal to provide the auto adjustment by sending the second control signal to the graphic controller 13a.

Hereinbelow, an interlock between the controller 34a of the display apparatus 30a of FIG. 2 and the RAM-resident control routine 12a of the computer 10a will be described by way of example in a programming level.

First, when the auto adjustment is selected through the auto adjustment selecting portion 35a, the controller 34a of the display apparatus 30a sets a flag as “Ready_To_AutoAdjust,” meaning that a user is ready to execute the auto adjustment.

Here, the RAM-resident control routine 12a periodically checks the flag related to the auto adjustment of the display apparatus 30a through a DDC communication line. Further, in the case where the flag is “Ready_To_AutoAdjust,” the video signal to provide the auto adjustment is loaded into the main memory 11a, and then the flag is set as “Load_lmage_For_AutoAdjust.”

Then, when it is checked that the flag is changed into “Load_lmage_For_AutoAdjust,” the controller 34a executes the auto adjustment. Then, when the auto adjustment is ended, the controller 34a sets the flag as “Done_AutoAdjust.”

Here, when the flag is changed into “Done_AutoAdjust,” the RAM-resident control routine 12a stops outputting the video signal to provide the auto adjustment and initializes the flag as “NotReady_To_AutoAdjust.”

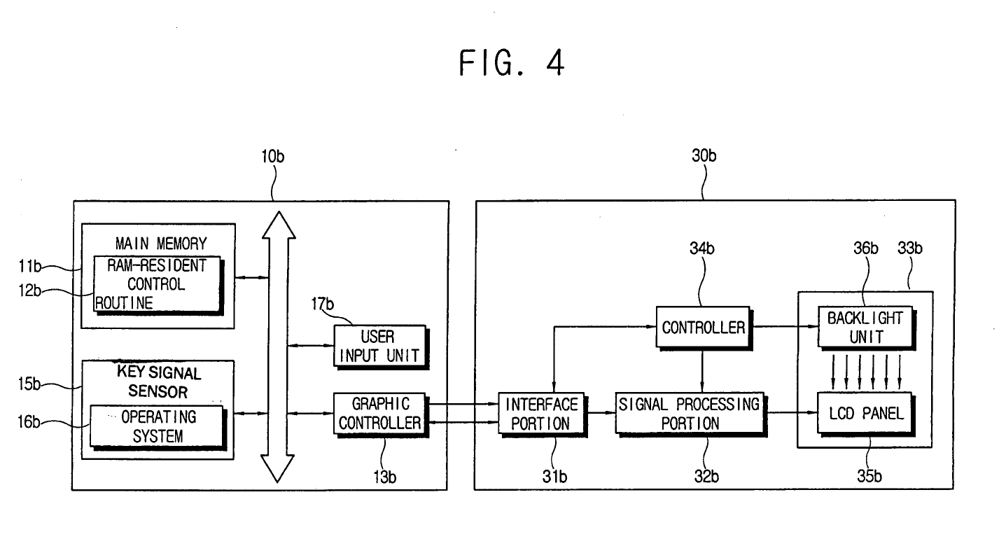

Hereinbelow, a display system according to another embodiment of the present general inventive concept will be described with reference to FIG. 4. The display system of FIG. 4 may comprise a display apparatus 30b to display a picture, and a computer 10b to output a video signal to the display apparatus 30b.

The display apparatus 30b may comprise an interface portion 31b, a signal processing portion 32b, a display portion 33b, and a controller 34b. The interface portion 31b, the signal processing portion, 32b, the display portion 33b, and the controller 34b are similar to the interface portion 31, the signal processing portion 32, the display portion 33, and the controller 34 described above (see FIG. 1).

The computer 10b may comprise a user input unit 17b to output a key signal corresponding to a user's selection, and a key signal sensor 15b to sense whether the key signal is output from the user input unit 17b. Further, the display portion 33b of the display apparatus 30b may comprise an LCD panel 35b, and a backlight unit 36b to illuminate the LCD panel 35b.

The user input unit 17b may include an input unit of the computer 10b, e.g., a keyboard, and a mouse. Alternatively, the user input unit 17b may include various input units such as a stylus pen, a pen mouse, a keypad, a touch pad, etc., as long as it can input the key signal to the computer 10b.

When there is no key signal from the user input unit 17b within a predetermined period of time, the key signal sensor 15b outputs an event signal (hereinafter, referred to as “third event signal”) corresponding to the no key signal. As shown in FIG. 4, the key signal sensor 15b may include an operating system 16b having a power management. Thus, the operating system 16b can output the third event signal when there is no key signal through the user input unit 17b within a predetermined period of time. Alternatively, the key signal sensor 15b may include a software program separate from the operating system 16b, or a hardware component such as a chipset or the like.

Meanwhile, when the third event signal is received from the operating system 16b of the key signal sensor 15b, a RAM-resident control routine 12b, residing in a main memory 11b of the computer 10b, allows a graphic controller 13b to output a control signal (hereinafter, referred to as “third control signal”) corresponding to the third event signal.

When the third control signal is received through the interface portion 31b, the controller 34b of the display apparatus 30b turns off the backlight unit 36b. Thus, when a user does not use the user input unit 17b within a predetermined period of time, the RAM-resident control routine 12b turns off the backlight unit 36b, to thereby reduce power consumption in the display system.

On the other hand, when the key signal is output from the user input unit 17b from a state in which there is no key signal, the operating system 16b outputs an event signal (hereinafter, referred to as “fourth event signal”) corresponding to the output of the key signal. When the fourth event signal is received, the RAM-resident control routine 12b allows the graphic controller 13b to output a control signal (hereinafter, referred to as “fourth control signal”) corresponding to the fourth event signal.

When the fourth control signal is received through the interface portion 31b, the controller 34b of the display apparatus 30b turns on the backlight unit 36b. That is, the backlight unit 36b of the display apparatus 30b, turned off accordingly as the user input unit 17b is not selected within a predetermined period of time, is turned on again when the user selects the user input unit 17b.

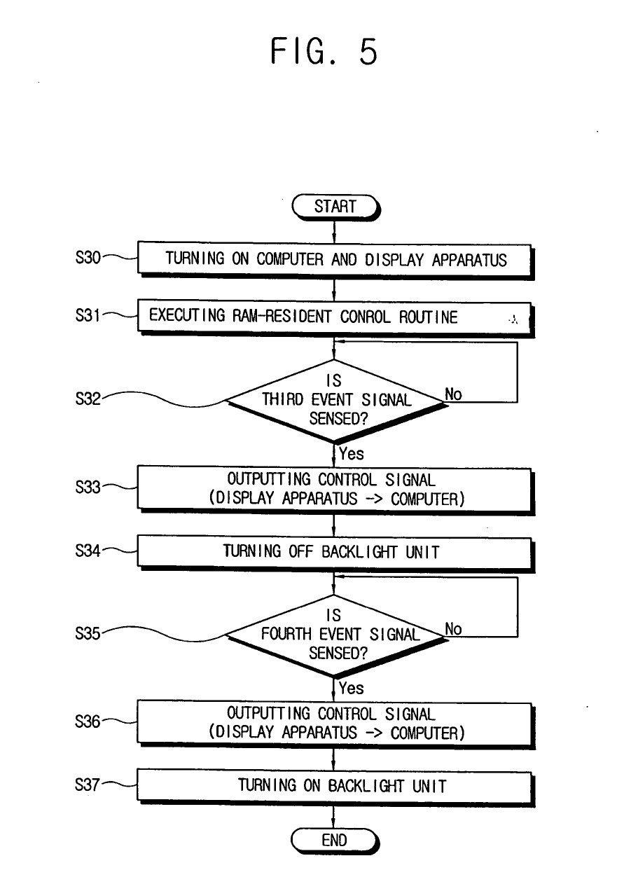

Hereinbelow, a control method of the display system of FIG. 4 will be described with reference to FIG. 5.

At operation S30, the computer 10b and the display apparatus 30b are turned on, wherein that the computer 10b starts booting. At operation S31, the RAM-resident control routine 12b is executed after booting the computer 10b and resides in the main memory 11b.

At operation S32, the RAM-resident control routine 12b checks whether the third event signal is received from the operating system 16b. When the third event signal is sensed, at operation S33, the RAM-resident control routine 12b allows the graphic controller 13b to output the third control signal to the display apparatus 30b.

At operation S34, when the third control signal is received through the interface portion 31b, the controller 34b of the display apparatus 30b turns off the backlight unit 36b.

Further, at operation S35, the RAM-resident control routine 12b checks whether the fourth event signal is received from the operating system 16b. When the forth event signal is sensed, at operation S36, the RAM-resident control routine 12b allows the graphic controller 13b to output the fourth control signal to the display apparatus 30b.

At operation S37, when the fourth control signal is received through the interface portion 31b, the controller 34b of the display apparatus 30b turns on the backlight unit 36b.

The controller 34, 34a, or 34b of the respective display apparatus 30, 30a, or 30b according to the various embodiments of the present general inventive concept can display an OSD (on screen display) on the respective display portion 33, 33a, or 33b, wherein the OSD can allow a user to select one of a function-on and a function-off.

Thus, a user can select one of the function-on and the function-off through the OSD. In a case where a user selects the function-on through the OSD, the controller 34, 34a, or 34b operates as described above when one of the first, third and fourth control signal is received.

In contrast, in a case where the user selects the function-off through the OSD, the controller 34, 34a, or 34b does not operate even though one of the first, third and fourth control signal is received. That is, the controller 34, 34a, or 34b does not react to the control signal.

Thus, a user can select the execution of the aforementioned functions between the computer 10, 10a, or 10b and the respective display apparatus 30, 30a, or 30b.

Here, configuration to display the OSD as described above can be realized by use of a chip or the like separate from the controller 34, 34a, or 34b.

Thus, there can be provided a display apparatus comprising an interface portion to receive a video signal, a display portion to display a picture thereon, a signal processing portion to convert a format of the video signal to be displayable in the display portion, and a controller to control the display portion and/or the signal processing portion to adjust a display state of the picture displayed on the display portion, and a computer comprising a main memory, a graphic controller to output the video signal and capable of bi-directional communication with the interface portion, and a RAM-resident control routine resident in the main memory to allow the graphic controller to output a predetermined control signal corresponding to an event signal to the display apparatus when the event signal is sensed, wherein the controller controls the display portion and/or the signal processing portion on the basis of the control signal received through the interface portion. Thus, the computer and the display apparatus of the display system mutually recognize respective states thereof and interlock with each other.

As described above, various embodiments of the present general inventive concept provide a display apparatus, a display system and a control method thereof, in which a random access memory (RAM)-resident control routine resident in a main memory of a computer senses a predetermined event signal and outputs a control signal corresponding to the sensed event signal to the display apparatus, so that the display apparatus executes a preset operation corresponding to the control signal.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A display system comprising:
a display apparatus comprising an interface part to receive a video signal, a display part to display a picture thereon, a signal processing part to convert a format of the video signal to be displayable in the display part, and a controller to control the display part and/or the signal processing part to adjust a display state of the picture displayed on the display part; and
a computer comprising a main memory, a graphic controller to output the video signal to the display apparatus and capable of bi-directional communication with the interface part, and a RAM-resident control routine residing in the main memory to allow the graphic controller to output a predetermined control signal corresponding to an event signal to the display apparatus when the event signal is sensed, the controller controlling the display part and/or the signal processing part on the basis of the control signal received through the interface part.

2. The display system according to claim 1, wherein the display apparatus comprises an auto adjustment selecting part to select an auto adjustment;
the controller outputs an event signal corresponding to the selection of the auto adjustment to the computer through the interface part when the auto adjustment is selected;
the RAM-resident control routine outputs a predetermined video signal to provide the auto adjustment and a control signal to execute the auto adjustment to the display apparatus when the event signal corresponding to the selection of the auto adjustment is received through the graphic controller; and
the controller analyzes characteristics of the video signal to provide the auto adjustment received through the interface part and executes the auto adjustment when the control signal to execute the auto adjustment is sensed.

3. The display system according to claim 2, wherein the controller outputs an event signal corresponding to an end of the auto adjustment to the computer through the interface part when the auto adjustment is ended, and the RAM-resident control routine stops outputting the video signal to provide the auto adjustment through the graphic controller when the event signal corresponding to the end of the auto adjustment is received through the graphic controller.

4. The display system according to claim 1, wherein the computer comprises a user input unit to output a key signal corresponding to a user's selection, and a key signal sensor to sense whether the key signal is output from the user input unit;
the display part of the display apparatus comprises an LCD panel, and a backlight unit to illuminate the LCD panel;
the key signal sensor outputs an event signal corresponding to no key signal when there is no key signal from the user input unit within a predetermined period of time;
the RAM-resident control routine outputs a control signal to turn off the backlight unit through the graphic controller when the event signal corresponding to the no key signal is received from the key signal sensor; and
the controller controls the backlight unit to be turned off when the control signal to turn off the backlight unit is received through the interface part.

5. The display system according to claim 4, wherein the key signal sensor outputs an event signal corresponding to an output of the key signal when the key signal is output from the user input unit from a state that there is no key signal;
the RAM-resident control routine outputs a control signal to turn on the backlight unit through the graphic controller when the event signal corresponding to the output of the key signal is received from the key signal sensor; and
the controller controls the backlight unit to be turned on when the control signal to turn on the backlight unit is received through the interface part.

6. The display system according to claim 4, wherein the key signal sensor includes an operating system.

7. The display system according to claim 2, wherein the controller displays an OSD (on screen display) on the display part to select one of a function-on and a function-off, the controller controls the display part and/or the signal processing part on the basis of the control signal in a case where the function-on is selected through the OSD, and the controller does not react to the control signal in the case where the function-off is selected through the OSD.

8. The display system according to claim 4, wherein the controller displays an OSD (on screen display) on the display part to select one of a function-on and a function-off, the controller controls the display part and/or the signal processing part on the basis of the control signal in a case where the function-on is selected through the OSD, and the controller does not react to the control signal in a case where the function-off is selected through the OSD.

9. A computer capable of bi-directional communication with a display apparatus, comprising:
a main memory; and
a RAM-resident control routine residing in the main memory to allow the computer to sense an event signal, generate a control signal corresponding to the event signal, and output the control signal to the display apparatus.

10. The computer according to claim 9, wherein the event signal is a signal corresponding to a request for an auto adjustment of the display apparatus, and the control signal is a signal to execute the auto adjustment.

11. The computer according to claim 10, further comprising information to provide the auto adjustment and the RAM-resident control routine instructs to computer to send the information as a video signal when the event signal corresponding to the request for the auto adjustment is sensed.

12. The computer according to claim 11, wherein the event signal is a signal corresponding to an end of the auto adjustment of the display apparatus, and the RAM-resident control routine stops the computer from sending the information when the event signal corresponding to the end of the auto adjustment is sensed.

13. The computer according to claim 9, wherein the event signal is a signal corresponding to no user input within a period of time, and the control signal is a signal to deactivate a part of the display apparatus.

14. The computer according to claim 9, wherein the event signal is a signal corresponding to a user input after a period of time with no user input, and the control signal is a signal to activate a part of the display apparatus.

15. A method of controlling a display system having a display apparatus and a computer to output a video signal to the display apparatus, the method comprising:
providing a RAM-resident control routine in a main memory of the computer when the computer is turned on;
allowing the RAM-resident control routine to sense whether a predetermined event signal is generated;
outputting a control signal from the RAM-resident control routine to the display apparatus corresponding to the event signal when the event signal is sensed through the RAM-resident control routine; and
controlling the display apparatus on the basis of the control signal.

16. The method according to claim 15, further comprising:
selecting an auto adjustment; and
outputting an event signal corresponding to the selecting of the auto adjustment from the display apparatus to the computer;
the outputting the control signal corresponding to the event signal comprising outputting a predetermined video signal to provide the auto adjustment and a control signal to execute the auto adjustment from the RAM-resident control routine to the display apparatus when the event signal corresponding to the selection of the auto adjustment is received through the graphic controller; and
the controlling of the display apparatus comprising analyzing characteristics of the video signal to provide the auto adjustment received through the interface part, and executing the auto adjustment when the control signal to execute the auto adjustment is sensed.

17. The method according to claim 15, further comprising:
outputting an event signal corresponding to an auto adjustment request from the display apparatus to the computer;
the outputting the control signal corresponding to the event signal comprising outputting a predetermined video signal to provide an auto adjustment of the display apparatus and a control signal to execute the auto adjustment from the RAM-resident control routine to the display apparatus when the event signal corresponding to the auto adjustment request is sensed; and
the controlling of the display apparatus comprising analyzing characteristics of the video signal to provide the auto adjustment, and executing the auto adjustment when the control signal to execute the auto adjustment is sensed.

18. The method according to claim 16, further comprising:
outputting an event signal corresponding to an end of the auto adjustment from the display apparatus to the computer when the auto adjustment is ended; and
stopping the outputting of the video signal corresponding to the auto adjustment when the event signal corresponding to the end of the auto adjustment is transmitted to the computer.

19. The method according to claim 15, further comprising:
sensing whether a key signal is input; and
outputting an event signal corresponding an absence of the key signal when there is no key signal input within a predetermined period of time;
the outputting of the control signal corresponding to the event signal comprising outputting a control signal to turn off a backlight unit of the display apparatus from the RAM-resident control routine to the display apparatus when the event signal corresponding to the absence of the key signal is sensed; and
the controlling of the display apparatus comprising turning off the backlight unit when the control signal to turn of the back light unit is sensed.

20. The method according to claim 19, further comprising:
outputting an event signal corresponding to an output of the key signal when the key signal is output from the user input unit in a state that there is no key signal;
the outputting of the control signal corresponding to the event signal comprising outputting a control signal to turn on the backlight unit from the RAM-resident control routines to the display apparatus when the event signal corresponding to the output of the key signal is received to the RAM-resident control routine; and
the controlling the display apparatus comprising turning on the backlight unit on the basis of the control signal to turn on the back light unit received from the computer.

21. A display apparatus comprising:
an interface part to receive a video signal from a computer;
a display part to display a picture thereon;
a signal processing part to convert a format of the video signal to be displayable in the display part;
an auto adjustment selecting part to select an auto adjustment; and
a controller to output an event signal to the computer corresponding to the selection of the auto adjustment through the interface part when the auto adjustment is selected through the auto adjustment selecting part, to control the signal processing part and/or the display part to display the picture on the display part on the basis of a video signal to provide the auto adjustment received from the computer through the interface part corresponding to the event signal, and to control the signal processing part and the display part to execute the auto adjustment on the basis of a control signal received from the computer through the interface part corresponding to the event signal.
